(19) United States
(12) Patent Application Publication
(10) Pub. No.: US 2024/0177182 A1
(43) Pub. Date: May 30, 2024

(54) DEMAND PREDICTION DEVICE, DEMAND PREDICTION METHOD, AND RECORDING MEDIUM

(71) Applicants: NEC Corporation, Tokyo (JP); NEC SOLUTION INNOVATORS, LTD, Tokyo (JP)

(72) Inventors: Naoki WASHIZUKA, Tokyo (JP); Kyohko Akazawa, Tokyo (JP)

(73) Assignees: NEC CORPORATION, Tokyo (JP); NEC SOLUTION INNOVATORS, LTD., Tokyo (JP)

(21) Appl. No.: 18/515,777

(22) Filed: Nov. 21, 2023

(30) Foreign Application Priority Data
Nov. 28, 2022 (JP) 2022-188845

(51) Int. Cl. G06Q 30/0202

(52) U.S. Cl. CPC G06Q 30/0202

(57) ABSTRACT

A demand prediction device of the present disclosure includes a model acquisition means that acquires a single article prediction model that predicts a demand of a target product and a category prediction model that predicts a demand of a category including the target product, a calculation means that calculates accuracy of demand prediction of the target product in the single article prediction model and the category prediction model, and an adoption means that adopts any one of the single article prediction model and the category prediction model based on the accuracy.

This application is based upon and claims the benefit of priority from Japanese Patent Application No. 2022-188845, filed on Nov. 28, 2022, the disclosure of which is incorporated herein in its entirety by reference.

### TECHNICAL FIELD

The present disclosure relates to a demand prediction device, a demand prediction method, and a recording medium.

### BACKGROUND ART

There is a demand for a method for enhancing prediction accuracy in a case where a demand of a product is predicted using a demand prediction model generated by artificial intelligence (AI).

For example, PTL 1 (JP 2021-103373 A) discloses that, in a case of performing demand prediction of a product, a demand prediction model is changed according to a data amount of past sales results, and as the data amount of the sales results increases, the demand prediction of the product is performed using a demand prediction model with high prediction accuracy.

### SUMMARY

An object of the present disclosure is to provide a demand prediction device capable of improving accuracy of demand prediction of a product regardless of the amount of learning data.

According to an aspect of the present disclosure, there is provided a demand prediction device including a model acquisition means that acquires a single article prediction model that predicts a demand of a target product and a category prediction model that predicts a demand of a category including the target product, a calculation means that calculates accuracy of demand prediction of the target product in the single article prediction model and the category prediction model, and an adoption means that adopts any one of the single article prediction model and the category prediction model based on the accuracy.

According to another aspect of the present disclosure, there is provided a demand prediction method causing a computer to execute acquiring a single article prediction model that predicts a demand of a target product and a category prediction model that predicts a demand of a category including the target product, calculating accuracy of demand prediction of the target product in the single article prediction model and the category prediction model, and adopting any one of the category prediction models.

According to still another aspect of the present disclosure, there is provided a program for causing a computer to execute acquiring a single article prediction model that predicts a demand of a target product and a category prediction model that predicts a demand of a category including the target product, calculating accuracy of demand prediction of the target product in the single article prediction model and the category prediction model, and adopting any one of the category prediction models.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration including a demand prediction device according to the present disclosure;

FIG. 2 is a diagram illustrating a hardware configuration in which the demand prediction device according to the present disclosure is achieved by a computer device and a peripheral device of the computer device;

FIG. 3 is an example of a screen for outputting information of a prediction model by an output unit in the present disclosure;

FIG. 4 is another example of a screen for outputting information of a prediction model by the output unit in the present disclosure; and

FIG. 5 is a flowchart illustrating an operation of demand prediction in the present disclosure.

### EXAMPLE EMBODIMENT

First, an outline of a demand prediction device 100 according to the present disclosure will be described. The demand prediction device 100 includes a model acquisition means that acquires a single article prediction model that predicts a demand of a target product and a category prediction model that predicts a demand of a category including the target product, a calculation means that calculates accuracy of demand prediction of the target product in the single article prediction model and the category prediction model, and an adoption means that adopts any one of the single article prediction model and the category prediction model based on the accuracy. According to this configuration, the demand prediction device 100 adopts any one of the single article prediction model and the category prediction model based on the accuracy of the demand prediction of the target product in the single article prediction model and the category prediction model. Therefore, when the demand of the product is predicted using the adopted prediction model, the accuracy of the demand prediction can be enhanced regardless of an amount of learning data.

### First Example Embodiment

The demand prediction device 100 according to the present disclosure is a device for performing demand prediction of a product to be sold at a retail store, such as food items such as fresh food items and daily necessities, or household goods. As a specific example of the present disclosure, it is assumed that a demand such as a sales quantity indicating how much a certain store sells a product (hereinafter, referred to as a target product) to be predicted is predicted. The demand prediction device 100 may be configured as an order placement system capable of placing an order for the quantity of target products necessary for the store based on the predicted demand.

In the present disclosure, as a demand prediction target period, for example, a predetermined period such as one day or one week, a period corresponding to an order interval, or the like is considered. The present disclosure will be mainly described assuming a case where a daily sales quantity of a target product in a specific store is predicted.

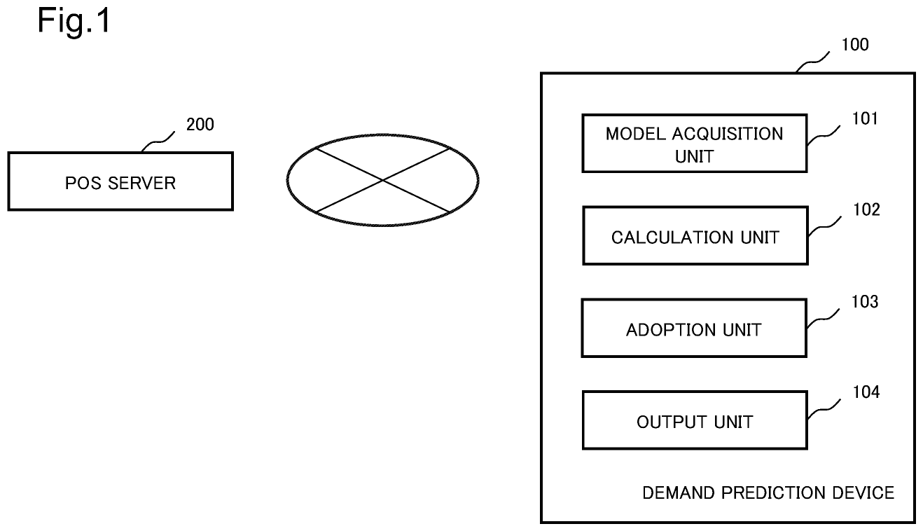

FIG. 1 is a diagram illustrating a configuration including the demand prediction device 100 according to the present disclosure. Referring to FIG. 1, the demand prediction device 100 acquires data necessary for demand prediction from a point of sale (POS) server 200 via a communication I/F 508 for network connection described later. The POS server 200 stores, for example, a product sales history and a sales quantity for each product.

As illustrated in FIG. 1, the demand prediction device 100 includes a model acquisition unit 101, a calculation unit 102, an adoption unit 103, and an output unit 104. Next, a configuration of the demand prediction device 100 according to the present disclosure will be described in detail.

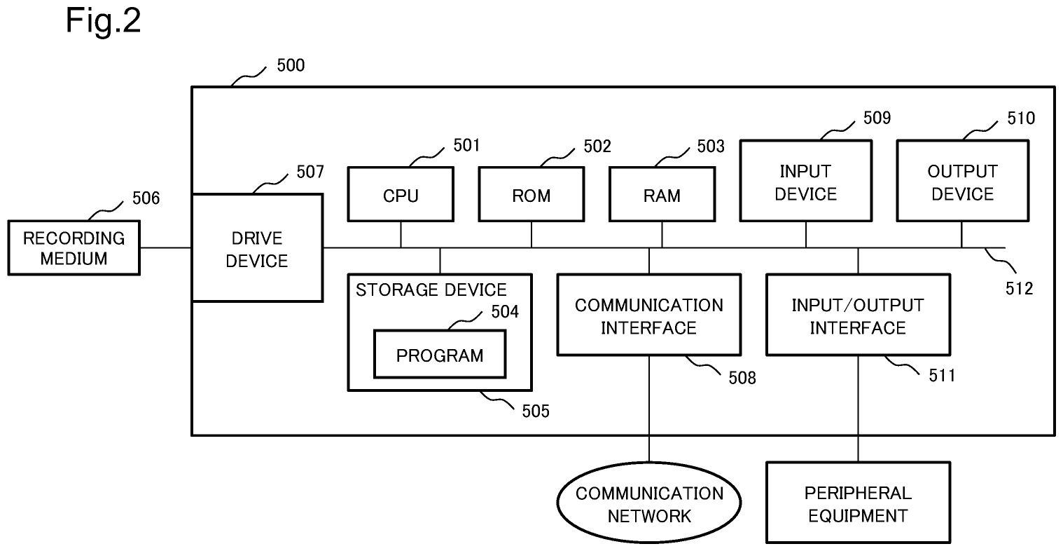

FIG. 2 is a diagram illustrating an example of a hardware configuration in which the demand prediction device according to the present disclosure is achieved by a computer device 500 including a processor. As illustrated in FIG. 2, the demand prediction device 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data.

In the present disclosure, the storage device 505 stores each prediction model of a single article prediction model that predicts a demand of the target product and a model that acquires a category prediction model that predicts a demand of a category including the target product.

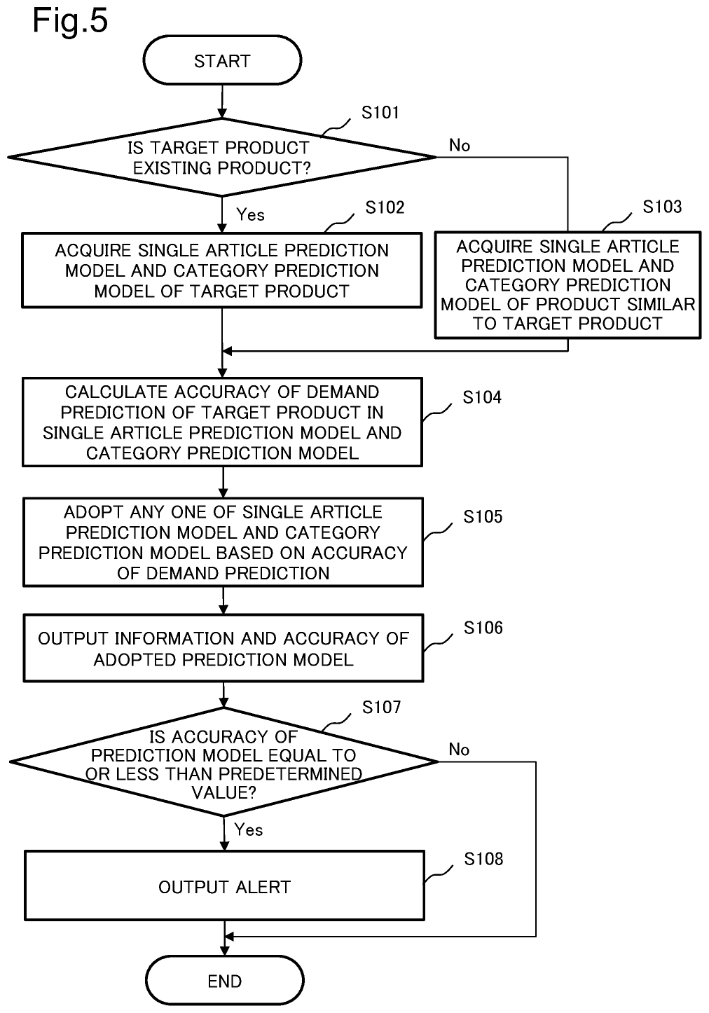

The CPU 501 operates an operating system to control the entire demand prediction device 100 according to the present disclosure. The CPU 501 reads a program and data from a recording medium 506 mounted on a drive device 507 or the like to a memory, for example. The CPU 501 functions as the model acquisition unit 101, the calculation unit 102, the adoption unit 103, the output unit 104, and a part thereof in present disclosure, and executes processing or a command in the flowchart illustrated in FIG. 5 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display device, and is used to confirm output.

As described above, the present disclosure illustrated in FIG. 1 is achieved by the computer hardware illustrated in FIG. 2. However, means for achieving each unit included in the demand prediction device 100 in FIG. 1 is not limited to the configuration described above. Further, the demand prediction device 100 may be achieved by one physically coupled device, or may be achieved by a plurality of device obtained by connecting physically separated two or more devices by wire or wirelessly. For example, the input device 509 and the output device 510 may be configured as a system connected to the computer device 500 via a network. The demand prediction device 100 according to the present disclosure illustrated in FIG. 1 can also be configured by cloud computing or the like.

The model acquisition unit 101 is a unit that acquires the single article prediction model that predicts the demand of the target product and the category prediction model that predicts the demand of the category including the target product. The single article prediction model is a prediction model generated for each product, and each product indicates, for example, a minimum unit in inventory management having the same product code such as a Japanese Article Number (JAN) code.

In the present disclosure, the category prediction model is a prediction model generated for each category included in the target product. The category of the product may be a broad category such as a sales floor such as vegetables, meat, confectionery, frozen food, fresh food, and seasoning. The category of the product may be a small category such as yogurt, milk, pudding, and jelly. The category of the product may be a category set in advance by a user who uses the demand prediction device 100.

The model acquisition unit 101 acquires the single article prediction model and the category prediction model from the storage device 505, for example. In this case, a generation means (not illustrated) generates each prediction model in advance by machine learning using the actual value of the past sales quantity as learning data, and stores the prediction model in the storage device 505.

When the target product is a new product, the model acquisition unit 101 acquires a single article prediction model and a category prediction model of a product similar to the target product. The model acquisition unit 101 may acquire each model of a product having a product name or a product feature similar to that of the target product from the storage device 505.

In the present disclosure, a method of generating a prediction model by the generation means is as follows. In the following description, the generation means generates the prediction model, but the model acquisition unit 101 may generate each prediction model.

For example, the generation means acquires, from the POS server 200, learning data including at least an actual value of a daily sales quantity of the target product several days ago to several tens of days ago, and generates the single article prediction model. Similarly, the generation means acquires, from the POS server 200, learning data including at least an actual value of a sales quantity of a category including a target product of several days ago to several tens of days ago, and generates a category prediction model. The generation means may generate each prediction model by using, as the learning data, a moving average of the actual values of the sales quantity from several days ago to several tens of days ago to a day before a prediction execution date.

When generating the single article prediction model, for example, in a case where “∘∘ yogurt ΔΔ taste of A company” is the target product, the generation means uses the actual value of the sales quantity of the same product (that is, “∘∘ yogurt ΔΔ taste of A company”) of the same manufacturer as the learning data. However, when the data amount of the actual value of the sales quantity of the same product is small, the generation means may use the actual value of the sales quantity of the similar product of the same manufacturer as the learning data. For example, when “∘∘ yogurt ΔΔ taste of A company” is a target product, an actual value of a sales quantity of “∘∘ yogurt ΔΔ taste of A company” in which a main part of a product name matches with that of the target product may be used for learning data.

When generating the category prediction model, the generation means uses the actual value of the sales quantity of the product group having the same category for the learning data. For example, in a case where “∘∘ yogurt ΔΔ taste of A company” is the target product, the generation means uses, for example, actual values of the sales quantities of a product (That is, “∘∘ yogurt ΔΔ taste of A company”) having a similar product name of the same manufacturer and a similar product (that is, “∘∘ yogurt of B company”) of another manufacturer for the learning data.

In the present disclosure, the prediction model is generated for each store. As the prediction model, it is sufficient that the sales quantity is an objective variable and the objective variable is represented by a linear sum of explanatory variables, and a content of a prediction expression (prediction model) is arbitrary. As the explanatory variable, a variable corresponding to a factor that affects the sales quantity is used.

The factor is, for example, calendar information (weekday/holiday, day of week) of a demand prediction target date, weather information (highest temperature, lowest temperature, weather), or information of past results such as the number of customers or the sales quantity. As a factor, for example, a sales promotion activity (campaign) such as a discount, an event (neighborhood event) held near a store, an event (special event) held in a store, an advertisement in media such as a television and a magazine, and a special factor occurring before or after a demand prediction target date such as an introduction article (CM/media) may be included. However, the factor is not limited thereto as long as it is information that affects the sales quantity and the number of customers.

The factor information may be received an input from the user, may read information stored in advance in the storage device 505, or may be acquired from another device such as the POS server 200 or an external system (not illustrated) via a network. Furthermore, the adoption unit 103 may calculate a moving average or the like using the number of customers or the sales quantity acquired from another device, and use the calculated value as an explanatory variable. The model acquisition unit 101 outputs the acquired single article prediction model and category prediction model to the calculation unit 102.

The calculation unit 102 calculates the accuracy of the demand prediction of the target product in the single article prediction model and the category prediction model. Specifically, first, the calculation unit 102 calculates each prediction result of the demand of the target product by substituting the explanatory variable value of the day to be predicted into each prediction model. The date to be predicted is a past date on which the actual value of the sales quantity exists. Next, the calculation unit 102 calculates an error rate between the prediction result of the target product by each prediction model and the actual value of the actual sales quantity of the target product, and calculates the accuracy of the demand prediction of each prediction model.

The adoption unit 103 is a unit that adopts any one of the single article prediction model and the category prediction model based on the accuracy of the demand prediction. The adoption unit 103 compares the accuracy of each prediction model input from the calculation unit 102 and adopts a prediction model with high accuracy. For example, the adoption unit 103 stores and manages information of the prediction model adopted for each product in the storage device 505.

The output unit 104 is a unit that outputs information of the adopted prediction model. The output unit 104 is achieved by, for example, a display device. The output unit 104 outputs information on which prediction model of the single article prediction model or the category prediction model is adopted. The output unit 104 may also output information of the model such as conditional branching of the model or a model expression. The output unit 104 may display any one of the prediction result of the sales quantity of the target product by the adopted prediction model and the accuracy of the prediction model, or may display an icon or the like instructing relearning.

The output unit 104 may output the information of the prediction model at the timing when the adoption unit 103 adopts any prediction model for the target product. The output unit 104 may output the information of the prediction model in the storage device 505 in a case where the operation for outputting the information of the prediction model is performed on the demand prediction device 100 by the operation of the user.

When displaying a list of prediction results by the prediction model for each product, the output unit 104 may display which prediction model is used to predict the prediction result. The output unit 104 may display an icon or the like for instructing relearning of the prediction model of the target product at a timing when the accuracy of the adopted prediction model becomes equal to or less than a predetermined value or at a timing when the accuracy of the prediction model falls below a threshold value a predetermined number of times or more. The output unit 104 may display an icon or the like for instructing relearning of the prediction model of the product when a predetermined period (for example, several months) has elapsed since generation of the adopted prediction model.

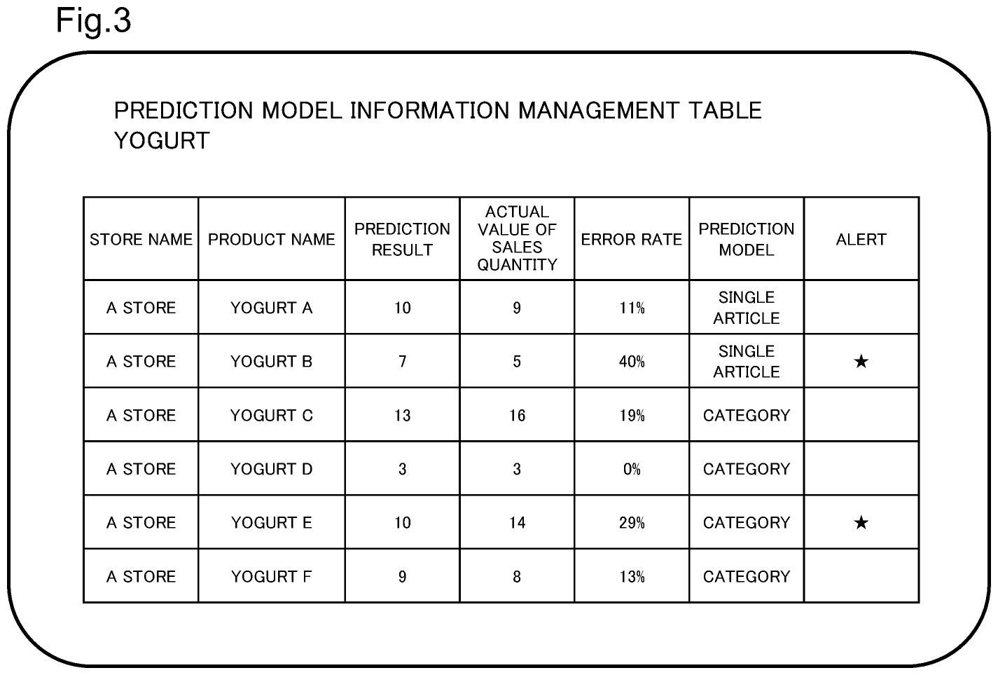

FIG. 3 is an example of a screen for outputting information of the prediction model by the output unit 104 in the present disclosure. In the example of FIG. 3, in store A, the prediction results of six types of yogurt prediction models, the actual value of the sales quantity, the error rate (accuracy), and which prediction model is used to predict the results are displayed. As illustrated in FIG. 3, an alert may be output when the error rate is equal to or greater than a predetermined value. In the example of FIG. 3, the output unit 104 outputs an alert to yogurt B having an error rate of 40%. In a case where the error rate is equal to or greater than a predetermined value, the output unit 104 may highlight the characters by thickening the characters or changing the color as an alert.

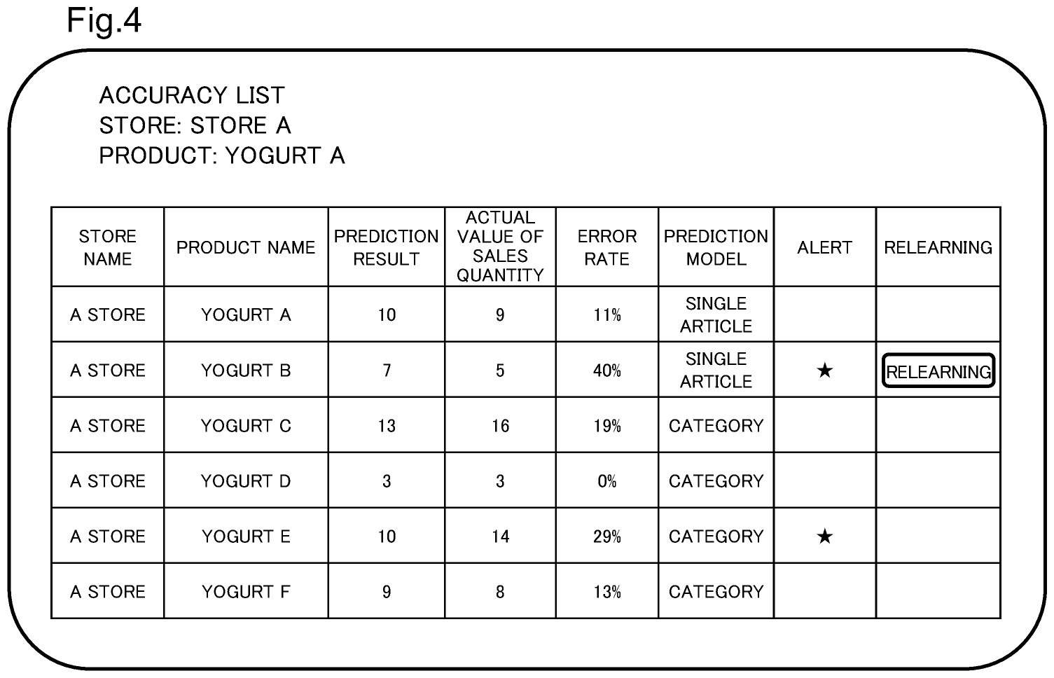

FIG. 4 is another example of a screen for outputting the information of the prediction model by the output unit 104 in the present disclosure. In the example of FIG. 4, in a store A, the prediction result by the daily model of yogurt A, the actual value of the sales quantity, the error rate, and which prediction model is used to predict the result are displayed. Also in FIG. 4, an alert may be output when the error rate is equal to or greater than a predetermined value. As illustrated in FIG. 4, the output unit 104 may display an icon or the like for instructing relearning of the model when the error rate is equal to or greater than a predetermined value. In the example of FIG. 4, a relearning icon is displayed for the yogurt B. The user can instruct the demand prediction device 100 to perform relearning by pressing this icon.

The operation of the demand prediction device 100 configured as described above will be described with reference to the flowchart of FIG. 5.

FIG. 5 is a flowchart illustrating an outline of an operation of the demand prediction device 100 according to the present disclosure. The processing according to this flowchart may be executed based on program control by the processor described above. For example, the demand prediction device 100 repeats the processing according to this flowchart every time the demand of the target product is predicted.

As illustrated in FIG. 5, first, in a case where the product is an existing product (S101; Yes), the model acquisition unit 101 acquires a single article prediction model and a category prediction model of the target product (Step S102). Meanwhile, when the target product is not the existing product but a new product (S101; No), the model acquisition unit 101 acquires a single article prediction model and a category prediction model of a product similar to the target product (Step S103). Next, the calculation unit 102 calculates the accuracy of the demand prediction of the target product in a predetermined period using the single article prediction model and the category prediction model (Step S104). Next, the adoption unit 103 adopts any one of the single article prediction model and the category prediction model based on the accuracy of the demand prediction (Step S105). Next, the output unit 104 outputs the information of the adopted model and the accuracy of the information (Step S106). Next, in a case where the accuracy of the adopted prediction model is equal to or less than a predetermined value (S107; Yes), the output unit 104 outputs an alert (Step S108). Meanwhile, in a case where the accuracy of the adopted prediction model is not equal to or less than the predetermined value (S107; No), the output unit 104 does not output the alert and ends the operation. Thus, the demand prediction device 100 terminates the operation.

In the demand prediction device 100 according to the present disclosure, the adoption unit 103 adopts any one of the single article prediction model and the category prediction model based on the accuracy of the demand prediction. In this case, the accuracy of the demand prediction of the product can be enhanced regardless of the amount of learning data by adopting the prediction model with high accuracy of the demand prediction.

In the present disclosure, in a case where the target product is a new product, the model acquisition unit 101 acquires a single article prediction model and a category prediction model of a product similar to the target product. As a result, even when there is no learning data, demand prediction can be performed by adopting a highly accurate prediction model.

Although the present invention has been described with reference to the exemplary embodiments, the present invention is not limited to the exemplary embodiments. Various modifications that can be understood by those skilled in the art can be made to the configuration and details of the present invention within the scope of the present invention.

For example, although the plurality of operations are described in order in the form of a flowchart, the order of description does not limit the order of executing the plurality of operations. Therefore, when each example embodiment is implemented, the order of the plurality of operations can be changed within a range that does not interfere in content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

In the invention described in JP 2021-103373 A, a demand prediction model is changed according to a data amount of sales result. However, an appropriate demand prediction model is not necessarily determined only by the amount of learning data.

An example of the effect of the present disclosure is to provide a demand prediction device capable of improving the accuracy of demand prediction of products regardless of the amount of learning data.

1. A demand prediction device comprising:
a memory storing instructions; and
at least one processor configured to execute the instructions to:
acquire a single article prediction model that predicts a demand of a target product and a category prediction model that predicts a demand of a category including the target product;
calculate accuracy of demand prediction of the target product in the single article prediction model and the category prediction model; and
adopt any one of the single article prediction model and the category prediction model based on the accuracy.

2. The demand prediction device according to claim 1, wherein the at least one processor is further configured to execute the instructions to:
output information of the adopted prediction model.

3. The demand prediction device according to claim 1, wherein the at least one processor is further configured to execute the instructions to:
when the target product is a new product, acquire the single article prediction model and the category prediction model of a product similar to a target product.

4. The demand prediction device according to claim 2, wherein the at least one processor is further configured to execute the instructions to:
when a prediction result of demand for each product is displayed in a list, display which prediction model is used to predict the prediction result.

5. The demand prediction device according to claim 2, wherein the at least one processor is further configured to execute the instructions to:
display an error rate between a prediction result by the adopted prediction model and an actual value.

6. The demand prediction device according to claim 5, wherein the at least one processor is further configured to execute the instructions to:
when the error rate is equal to or greater than a predetermined value, output an alert.

7. A demand prediction method causing a computer to execute:
acquiring a single article prediction model that predicts a demand of a target product and a category prediction model that predicts a demand of a category including the target product;
calculating accuracy of demand prediction of the target product in the single article prediction model and the category prediction model; and
adopting any one of the category prediction models.

8. A non-transitory computer-readable recording medium that records a program for causing a computer to execute:
acquiring a single article prediction model that predicts a demand of a target product and a category prediction model that predicts a demand of a category including the target product;
calculating accuracy of demand prediction of the target product in the single article prediction model and the category prediction model; and
adopting any one of the category prediction models.
